(19) United States
(12) Patent Application Publication
(10) Pub. No.: US 2020/0073891 A1
(43) Pub. Date: Mar. 5, 2020

(54) SYSTEMS AND METHODS FOR CLASSIFYING DATA IN HIGH VOLUME DATA STREAMS

(71) Applicant: New Relic, Inc., San Francisco, CA (US)

(72) Inventors: Guy FIGHEL, San Francisco, CA (US); Avishay WEINBAUM, San Francisco, CA (US)

(21) Appl. No.: 16/554,489

(22) Filed: Aug. 28, 2019

Related U.S. Application Data
(60) Provisional application No. 62/723,935, filed on Aug. 28, 2018.

(51) Int. Cl. G06F 16/906; G06F 16/9035; G06F 16/9038; G06K 9/62

(52) U.S. Cl. CPC G06F 16/906; G06K 9/627; G06F 16/9038; G06F 16/9035

(57) ABSTRACT

Systems and method embodying the invention classify portions of a data stream that is received from a production environment. Portions of the data stream are compared to a plurality of templates to determine if the portions of the data appear to match a known template. If there is a match, the data is further analyzed in an attempt to classify the data as being of a one of a plurality of different types that correspond to the matched template.

This application claims priority to the filing date of U.S. Provisional Application No. 62/723,935, which was filed on Aug. 28, 2018, the contents of which are hereby incorporated by reference.

### BACKGROUND OF THE INVENTION

The present application discloses technology which is used to help a business keep a computer-based production environment operating efficiently and with good performance. The “production environment” could be any of many different things. In some instances, the production environment could be a networked system of computer servers that are used to run an online retailing operation. In another instance, the production environment could be a computer system used to generate computer software applications. In still other embodiments, the production environment could be a computer controlled manufacturing system. Virtually any sort of production environment that relies upon computers, computer software and/or computer networks could benefit from the systems and methods disclosed in this application.

To monitor the status of a production environment, various monitoring elements are installed within the production environment, and those monitoring elements report data to a production environment analysis system. Data streams received from the monitoring elements often require classification before the data within those streams can be stored and used. One example is where sensors monitoring various computer systems that form part of a production environment stream data to a production environment analysis system. The production environment analysis system uses the information in the data stream to determine if the production environment is operating within specifications. If the production environment analysis system determines that there may be a problem, then remedial action can be taken.

Typically, data classifiers are used to identify the different items of data within a data stream, and to classify each item of data as being a specific data type. Data produced by sensors and monitoring elements of a production environment can include a great variety of different data types that indicate the status of different devices, systems and software programs that make up the production environment. For that reason, a data classifier used with a complex production environment must be capable of correctly identifying a large number of different data types.

A data classifier is typically an algorithm running on a computer or server that implements classification. The algorithm is designed to map input data to a data category. Different classifiers use different algorithms, and the algorithms can vary greatly in how they accomplish the classification function. Good data classifiers, however, must be capable of accurately mapping input data into a large number of different data types. As a result, data classifiers can consume considerable processing power, and a classifier can take a relatively long period of time to classify a data item as corresponding to a particular data type.

In many instances, a production environment analysis system that determines the condition of a production environment does not itself have a data classifier. Instead, the production environment analysis system must send an analysis request to a separate, third party data classifier. The analysis request can be submitted to the data classifier using an API offered by the data classifier, and the analysis request would include data requiring classification. The production environment analysis system must then wait to receive a response from the data classifier that indicates the type of data that was included in the analysis request.

If the analysis being performed by the production environment analysis system is time critical, the delay involved in sending an analysis request to a third-party data classifier can be problematic. Also, the production environment analysis system must pay to use the services of the data classifier. Moreover, there is a processing cost involved in receiving the data from the sensors of the production environment, repackaging that data in a format acceptable to the data classifier, submitting analysis requests to the data classifier, and then reviewing the responses received from the data classifier. In light of these costs and drawbacks, it would be desirable to identify different types of data in high volume data streams more quickly, for a lower cost, and without the need to resort to a third-party data classifier.

### BRIEF DESCRIPTION OF THE DRAWINGS

FIG. 1 is a diagram of a production environment analysis system which could embody the invention;

FIG. 2 is a diagram of selected elements of an initial data classifier;

FIG. 3 is a flowchart illustrating steps of a first method embodying the invention that would be performed by one or more servers;

FIG. 4 is a diagram of a computer system and associated peripherals which could embody the invention, or which could be used to practice methods embodying the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

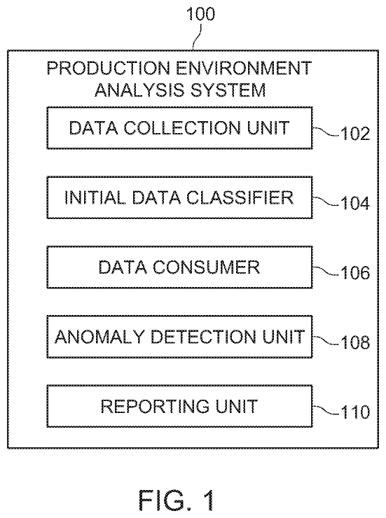

FIG. 1 illustrates selected elements of a production environment analysis system 100 that receives or obtains data from one or more production environments, that analyzes that data to determine whether issues or problems may be occurring, and that reports on any identified problems or issues. The production environment analysis system 100 could be setup to monitor only one production environment. Alternatively, the production environment analysis system 100 could be used to monitor multiple different production environments.

The production environment analysis system includes a data collection unit 102 that collects data from one or more production environments. Sensors and software installed within the production environment send data to the data collection unit 102 that reflects the current operational state of the production environment. Because production environments can be quite complex, the data that is sent to the data collection unit 102 can be of many different types. Often a single stream of data sent from the production environment to the data collection unit 102 includes multiple different types of data. The present invention is designed to attempt to determine what types of data are being received by the data collection unit 102 so that the data can be routed to the appropriate data consumers that will analyze the data and determine the current operation status of the production environment.

The production environment analysis system 100 includes an initial data classifier 104 that attempts to identify the types of data being received by the data collection unit. Details of how the initial data classifier 104 operate are provided below. If the initial data classifier 104 cannot determine the type of data for a portion of a data stream received by the data collection unit 102, the portion of unclassified data may be submitted to an external data classifier, as will be explained below.

The production environment analysis system 100 also includes one or more data consumers 106, which receive and analyze data received by the data collection unit 102. The data consumers 106 can take many different forms, depending on the type of data that is received by the data collection unit 102, which in turn depends on the production environment being analyzed. The data consumers 106 are typically configured to receive and analyze specific types of data. As a result, when the data collection unit 102 receives a stream of data from a production environment, it is the job of the initial data classifier 104 to attempt to determine what type of data each portion of the data stream corresponds to, and the initial data classifier 104 then submits the respective portions of the data to the appropriate data consumer 106. As mentioned, if the initial data classifier 104 cannot determine the type of a portion of the data received by the data collection unit 102, the initial data classifier 104 can submit that portion of the data stream to an external data classifier. Once the external data classifier identifies the type of an unknown portion of a data stream, the initial data classier 104 can then submit the data to the appropriate data consumer 106.

The production environment analysis system 100 also includes an anomaly detection unit 108 that uses the data received by the data collection unit 102 to determine if there are anomalous events occurring in a production environment. A reporting unit 110 can report on anomalous events detected by the anomaly detection unit 108, or the reporting unit 110 can indicate that a production environment is operating normally.

A production environment analysis system 100 would have many other elements and features in addition to those illustrated in FIG. 1. Thus, FIG. 1 should in no way be considered limiting of the production environment analysis system 100.

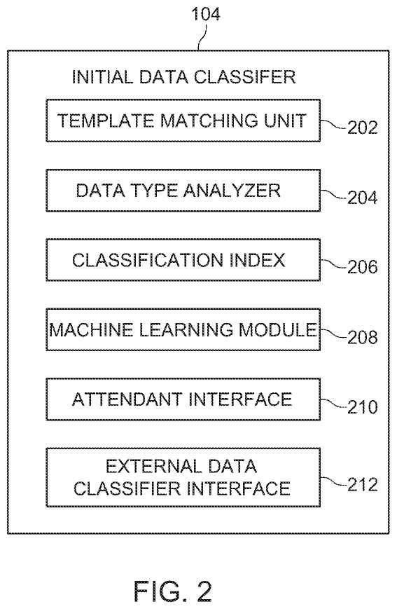

FIG. 2 illustrates selected elements of an initial data classifier 104 that is configured to analyze portions of a data stream received from a production environment in an attempt to classify each portion of the data stream as being of a certain type. The initial data classifier 104 includes a template matching unit that attempts to match one of a plurality of templates to a portion of the data received from a production environment. The templates to which the data is compared are selected based on characteristics of the production environment, and the types of data that one would expect to receive from the production environment.

In some instances, a portion of a stream of data may be tokenized, which essentially means chopping the data up into pieces, and likely removing any punctuation. A token is an instance of a sequence of characters in a document that are grouped together as a useful semantic unit. The resulting stream of tokens may then be used to attempt to classify the data type of the portion of the data stream. Once a received portion of a data stream has been tokenized, the tokens can be compared to known tokens as part of the classification process.

A classification index 206 lists the data types associated with each template. If a portion of a data stream received from a production environment matches a known template, a data type analyzer 204 attempts to identify the specific type data within the received portion of the data stream. This is done by checking with the classification index 206 to identify the various different types of data that correspond to the matched template. The degree of matching can be exact, or just to a determined level of confidence. If the data type analyzer 204 is successful in identifying the data type of the received portion of the data stream, the data is marked to indicate the data type, and the data is then passed on to a data consumer 106 that utilizes the identified type of date.

The initial data classifier 104 also includes a machine learning module 208 that attempts to identify unknown data types. Also, an attendant interface 210 can be used by system operators to help identify the type of data within a portion of a received data stream when the data type analyzer 104 is initially unable to determine the type of the data. The attendant interface 210 and the machine learning module 208 ultimately add to the classification index 206 to identify new data types, when new data types are received. As a result, the data type analyzer 204 can properly identify new data types with the assistance of the machine learning module 208 and the attendant interface. 210.

If the data type analyzer 204 is unable to determine the data type for a portion of a received data stream, and the attendant interface 210 also cannot identify the correct data type, then an external data classifier interface 212 can submit that unknown portion of the data stream to an external data classifier. Because it can take time for the external data classifier to identify the type of the unknown portion, and because it can cost money or resources, use of the external data classifier is typically a last resort.

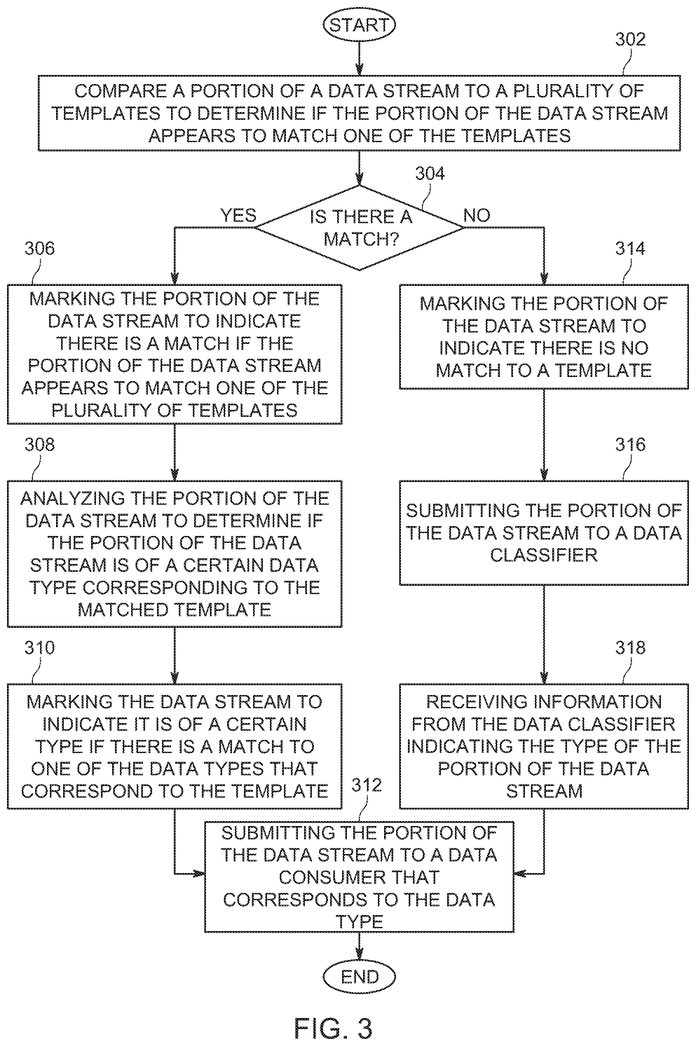

FIG. 3 illustrates steps of a method embodying the invention. The method is performed when a data collection unit 102 of a production environment analysis system 100 receives a stream of data from a production environment. The purpose of this method is to identify the types of each portion of the received data stream so that the individual portions of the data stream can be passed on to the correct data consumer 106 for analysis.

The method begins and proceeds to step 302, where a template matching unit 202 compares a portion of a received data stream to a plurality of templates that one suspects should correspond to the data being generated by the production environment. As mentioned above, the templates to which the portion of the data stream are compared are selected based on the characteristics of the production environment. The point of this comparison is to determine if the portion of the data stream appears to correspond to one of the known templates.

In step 304, a check is performed to determine if the portion of the data stream corresponds to one of the known data templates. If there is a match to one of the known templates, the method proceeds to step 306, where the portion of the data stream is marked to indicate that it corresponds to the known template. The method then proceeds to step 308, where a data type analyzer 204 attempts to identify the specific type of the data within the portion of the data stream. The data type analyzer can consult a classification index 206 that lists the various types of data that correspond to the matched template. If the data type analyzer 204 can identify the specific data type of the portion of the data stream, in step 310, the portion of the data stream is marked to indicate its type. Then, in step 312, the portion of the data stream is passed on to the data consumer 106 that is responsible for analyzing that type of data.

If the check performed in step 304 indicates that the portion of the data stream could not be matched to a known template, the method proceeds to step 314 where the portion of the data stream is marked to indicate that it did not match a known template. The method then proceeds to step 316, where an external data classifier interface 212 sends the portion of the data to an external data classifier. The method then proceeds to step 318, where the information identifying the data type of the portion of the data stream is received from the external data classifier. The method then proceeds to step 312, where the portion of the data stream is submitted to the data consumer 106 responsible for analyzing that type of data. The method then ends.

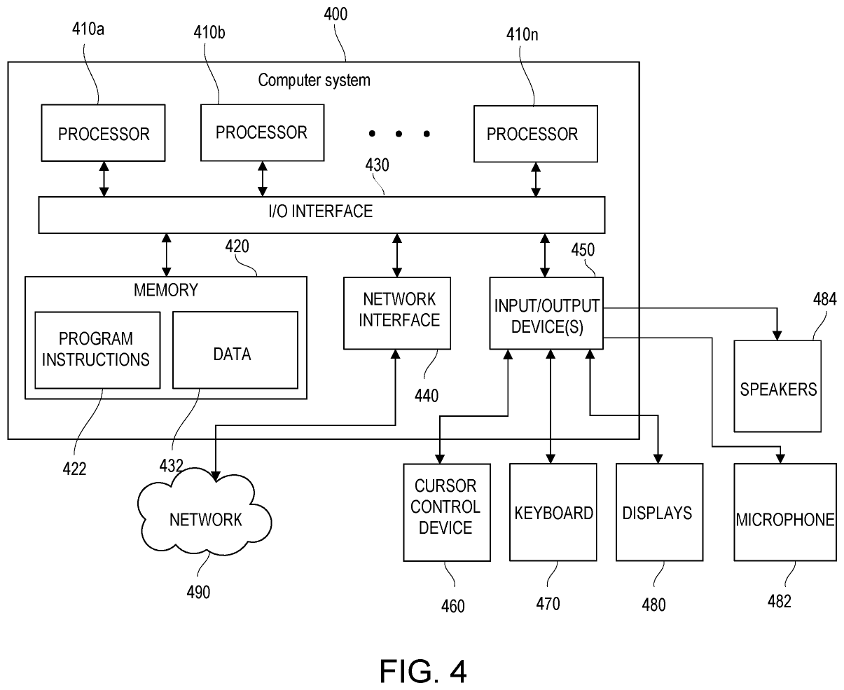

A method as illustrated in FIG. 4 would be performed for each portion of a data stream received from a production environment in an attempt to classify the data and pass it along to the correct data consumer.

The invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

FIG. 4 depicts a computer system 400 that can be utilized in various embodiments of the present invention to implement the invention according to one or more embodiments. The various embodiments as described herein may be executed on one or more computer systems, which may interact with various other devices. One such computer system is the computer system 400 illustrated in FIG. 4. The computer system 400 may be configured to implement the methods described above. The computer system 600 may be used to implement any other system, device, element, functionality or method of the above-described embodiments. In the illustrated embodiments, the computer system 400 may be configured to implement the disclosed methods as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, an input/output devices interface 450. The input/output devices interface 450 facilitates connection of external I/O devices to the system 400, such as cursor control device 460, keyboard 470, display(s) 480, microphone 482 and speakers 484. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, the computer system 400 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices interface 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

External input/output devices interface 450 may, in some embodiments, include one or more display terminals, keyboards, keypads, touchpads, scanning devices, voice or optical recognition devices, or any other devices suitable for entering or accessing data by one or more computer systems 400. Multiple input/output devices may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the operations and methods described above, such as the methods illustrated by the flowchart of FIG. 3. In other embodiments, different elements and data may be included.

Those skilled in the art will appreciate that the computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In many of the foregoing descriptions, a software application running on a telephony device may perform certain functions related to the disclosed technology. In alternate embodiments, a browser running on the telephony device may access a software application that is running on some other device via a data network connection. For example, the software application could be running on a remote server that is accessible via a data network connection. The software application running elsewhere, and accessible via a browser on the telephony device may provide all of the same functionality as an application running on the telephony device itself. Thus, any references in the foregoing description and the following claims to an application running on a telephony device are intended to also encompass embodiments and implementations where a browser running on a telephony device accesses a software application running elsewhere via a data network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of classifying a stream of data received from a production environment, where the stream of data includes multiple different types of data, comprising:
comparing a portion of the data stream to a plurality of templates to determine if the portion of the data stream matches any of the plurality of templates,
marking the portion of the data stream, when the portion of the data stream matches one of the templates, to indicate which of the plurality of templates the portion of the data stream matches;
marking the portion of the data stream to indicate that it does not match any of the plurality of templates if the portion of the data stream does not match any of the templates;
analyzing the portion of the data stream, when the portion of the data stream is marked to indicate that it matches one of the plurality of templates, to determine whether the portion of the data stream is one of a plurality of different data types that correspond to the matched template;
marking the portion of the data stream, when the portion of the data stream is determined to be a certain data type to indicate that the portions of the data stream is that certain data type; and
marking the portion of the data stream, when the portion of the data stream is determined to not be any of the data types corresponding to the matched template to indicate that the portion of the data stream is an unknown data type.

2. The method of claim 1, further comprising submitting the portion of the data stream to a data classifier for classification when the portion of the data stream is determined to not match any of the plurality of templates or when the data is marked as an unknown data type.

3. The method of claim 2, further comprising receiving, from the data classifier, information that indicates that the portion of the data stream is of a certain type.

4. The method of claim 3, further comprising:
marking the portion of the data stream to indicate that is the certain data type determined by the data classifier; and
submitting the portion of the data stream to a data consumer.

5. The method of claim 4, wherein the data consumer to which the portion of the data stream is submitted is a data consumer for the certain type of data that the portion of the data stream was determined to be.

6. The method of claim 1, further comprising submitting the portion of the data stream to a data consumer when the data stream is marked to indicate that it is a certain data type.

7. The method of claim 6, wherein the data consumer to which the portion of the data stream is submitted is a data consumer for the certain type of data that the portion of the data stream was determined to be.

8. The method of claim 1, wherein the analyzing step comprises:
obtaining information from a classification index that indicates the types of data that correspond to the matched template; and
determining whether the portion of the data stream is one of the types of data that correspond to the matched template.

9. The method of claim 1, wherein the portion of the stream of data is a textual stream of data.

10. A system for classifying a stream of data received from a production environment, where the stream of data includes multiple different types of data, comprising:
means for comparing a portion of the data stream to a plurality of templates to determine if the portion of the data stream matches any of the plurality of templates,
means for marking the portion of the data stream, when the portion of the data stream matches one of the templates, to indicate which of the plurality of templates the portion of the data stream matches;
means for marking the portion of the data stream to indicate that it does not match any of the plurality of templates if the portion of the data stream does not match any of the templates;
means for analyzing the portion of the data stream, when the portion of the data stream is marked to indicate that it matches one of the plurality of templates, to determine whether the portion of the data stream is one of a plurality of different data types that correspond to the matched template;
means for marking the portion of the data stream, when the portion of the data stream is determined to be a certain data type to indicate that the portions of the data stream is that certain data type; and
means for marking the portion of the data stream, when the portion of the data stream is determined to not be any of the data types corresponding to the matched template to indicate that the portion of the data stream is an unknown data type.

11. A for system classifying a stream of data received from a production environment, where the stream of data includes multiple different types of data, comprising:
a template matching unit that compares a portion of the data stream to a plurality of templates to determine if the portion of the data stream matches any of the plurality of templates, that marks the portion of the data stream, when the portion of the data stream matches one of the templates, to indicate which of the plurality of templates the portion of the data stream matches and that marks the portion of the data stream to indicate that it does not match any of the plurality of templates if the portion of the data stream does not match any of the templates; and
a data type analyzer that analyzes the portion of the data stream, when the portion of the data stream is marked to indicate that it matches one of the plurality of templates, to determine whether the portion of the data stream is one of a plurality of different data types that correspond to the matched template and that marks the portion of the data stream, when the portion of the data stream is determined to be a certain data type to indicate that the portions of the data stream is that certain data type and that marks the portion of the data stream, when the portion of the data stream is determined to not be any of the data types corresponding to the matched template to indicate that the portion of the data stream is an unknown data type.

12. The system of claim 11, further comprising an external data classifier interface that submits the portion of the data stream to an external data classifier for classification when the portion of the data stream is determined to not match any of the plurality of templates or when the data is marked as an unknown data type.

13. The system of claim 12, wherein the external data classifier index is configured to receive, from the external data classifier, information that indicates that the portion of the data stream is of a certain type.

14. The system of claim 13, wherein the data type analyzer is configured to mark the portion of the data stream to indicate that is the certain data type determined by the external data classifier, and the to submit the portion of the data stream to a data consumer.

15. The system of claim 14, wherein the data consumer to which the portion of the data stream is submitted is a data consumer for the certain type of data that the portion of the data stream was determined to be.

16. The system of claim 11, wherein the data type analyzer submits the portion of the data stream to a data consumer when the data stream is marked to indicate that it is a certain data type.

17. The system of claim 16, wherein the data consumer to which the portion of the data stream is submitted is a data consumer for the certain type of data that the portion of the data stream was determined to be.

18. The system of claim 11, wherein the data type analyzer obtains information from a classification index that indicates the types of data that correspond to the matched template, and wherein the data type analyzer determines whether the portion of the data stream is one of the types of data that correspond to the matched template.

19. The system of claim 11, wherein the portion of the stream of data is a textual stream of data.
